(19) United States
(12) Patent Application Publication
(10) Pub. No.: US 2015/0106205 A1
(43) Pub. Date: Apr. 16, 2015

(54) GENERATING AN OFFER SHEET BASED ON OFFLINE CONTENT

(71) Applicant: Google Inc., Mountain View, CA (US)

(72) Inventor: Robert B. Rose, Boulder, CO (US)

(73) Assignee: Google Inc., Mountain View, CA (US)

(21) Appl. No.: 14/055,400

(22) Filed: Oct. 16, 2013

(51) Int. Cl. G06Q 30/02

(52) U.S. Cl. CPC G06Q 30/0261; G06Q 30/0269
USPC 705/14.58

(57) ABSTRACT

Methods, systems, and apparatus include computer programs encoded on a computer-readable storage medium for providing an offer sheet to a user. A method includes: receiving an image from a user and additional information about the image; evaluating the image to identify content included in the image including using optical character recognition to identify text included in the image and object recognition techniques to identify objects included in the image; identifying location information including one or more of location of where the image was captured, location associated with the content included in the image or a current location of the user; identifying a plurality of eligible offers based on the identified content, the location information, the additional information, and a profile associated with the user; generating an offer sheet that includes the plurality of offers and a representation of the received image; and providing the offer sheet to the user.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for providing an offer sheet to a user. A method includes: receiving an image from a user and additional information about the image; evaluating the image to identify content included in the image including using optical character recognition to identify text included in the image and object recognition techniques to identify objects included in the image; identifying location information including one or more of location of where the image was captured, location associated with the content included in the image, or a current location of the user; identifying a plurality of eligible offers based on the identified content, the location information, the additional information, and a profile associated with the user; generating an offer sheet that includes the plurality of offers and a representation of the received image; and providing the offer sheet to the user.

In general, another aspect of the subject matter described in this specification can be implemented in computer program products. A computer program product is tangibly embodied in a computer-readable storage device and comprises instructions. The instructions, when executed by a processor, cause the processor to: receive an image from a user and additional information about the image; evaluate the image to identify content included in the image including using optical character recognition to identify text included in the image and object recognition techniques to identify objects included in the image; identify location information including one or more of location of where the image was captured, location associated with the content included in the image, or a current location of the user; identify a plurality of eligible offers based on the identified content, the location information, the additional information, and a profile associated with the user; generate an offer sheet that includes the plurality of offers and a representation of the received image; and provide the offer sheet to the user.

In general, another aspect of the subject matter described in this specification can be implemented in systems. A system includes: a text recognizer configured to identify text included in an image received from a user; an object recognizer configured to identify objects included in the image; an offer identifier configured to: identify location information including one or more of location of where the image was captured, location associated with the content included in the image or a current location of the user; identify a plurality of eligible offers based on the identified content, the location information, additional information received with the image, and a profile associated with the user; and an offer sheet generator configured to: generate an offer sheet that includes the plurality of offers and a representation of the received image; and provide the offer sheet to the user.

These and other implementations can each optionally include one or more of the following features. The location information can be used to assist in identifying content included in the image. A plurality of images can be received, the plurality of images can be evaluated, and identifying the plurality of offers can be based on the evaluating. The image can be part of a scene, the scene can be received, the scene can be evaluated including evaluating images and audio associated with the scene, and the identifying can be based on the evaluating of the scene. Receiving the additional information can include receiving context information from the user along with the image and the context information can be used to identify the eligible offers. The context information can be of the form of an audible command signal that provides context for what the user is interested in related to the image. The user can be enabled to share the offer sheet with other users. Enabling can include providing a control to enable the user to name the offer sheet, store the offer sheet, augment the offer sheet with other metadata, or share the offer sheet with the other users. Generating the offer sheet can include generating a map portion for inclusion in the offer sheet including a map of an area related to a location associated with the image. Generating the map portion can include generating a map including one or more indicators, wherein each indicator can be associated with a location on the map that is relevant to an offer of the plurality of offers. The offer sheet can be maintained as a business page accessible by the user that is configured to be updated at each viewing by the user. Information from the evaluating can be stored in the profile for use in identifying other content to serve to the user at another time.

Particular implementations may realize none, one or more of the following advantages. A content provider can present offers to a user that relate to image content captured by the user. A user can receive offers based on a captured image, with the offers relating to one or more of text included in the image, an object included in the image, the location at which the image was captured or other data related to the image.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing an offer sheet to a user.

FIG. 2 is a block diagram of an example system for providing an offer sheet to a user.

FIG. 3 illustrates an example campaign management user interface.

FIG. 4 is a flowchart of an example process for providing an offer sheet to a user.

FIG. 5 is a block diagram of computing devices that may be used to implement the systems and methods described in this document, as either a client or as a server or plurality of servers.

Like reference numbers and designations in the various drawings indicate like elements.

### DETAILED DESCRIPTION

A user can capture an image using a camera, mobile device, or some other device. The image can be, for example, of a landmark, printed material, or some other object. The image can be provided to a content management system in a number of ways. The content management system can evaluate the image to identify content included in the image, including using optical character recognition to identify text included in the image and object recognition techniques to identify objects included in the image. A set of offers can be identified based on the identified content and a profile associated with the user. An offer sheet can be generated and provided to the user, where the offer sheet includes the set of offers and, in some implementations, a representation (e.g., thumbnail) of the image.

For situations in which the systems discussed here collect information about users, or may make use of information about users, the users may be provided with an opportunity to control whether programs or features collect user information (e.g., information about a user's social network, demographics, social actions or activities, profession, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

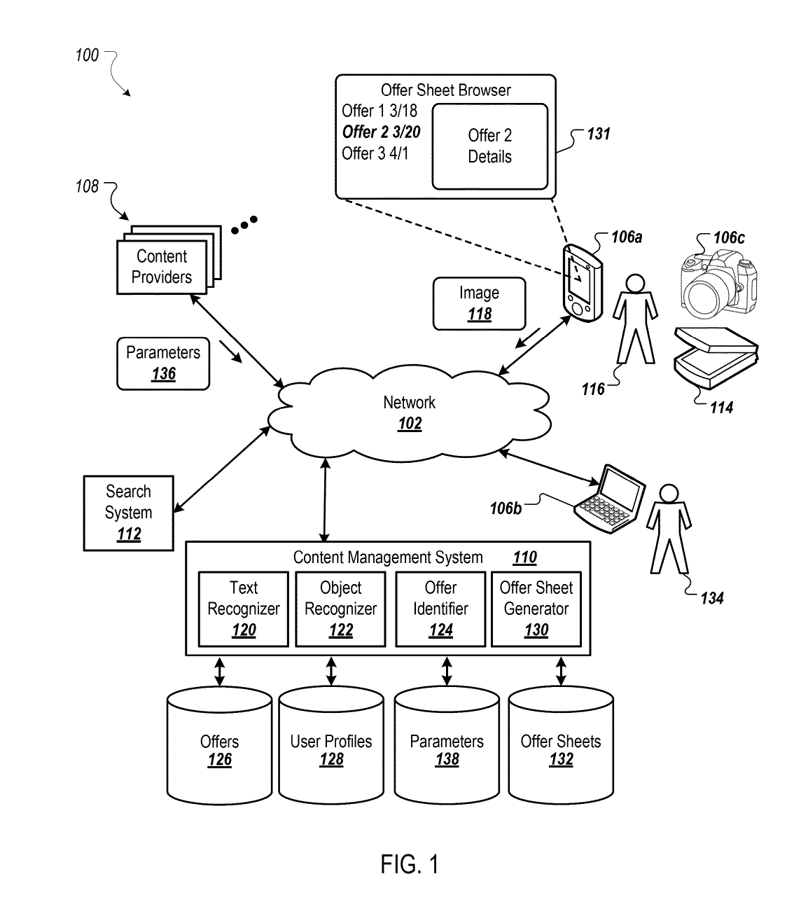

FIG. 1 is a block diagram of an example environment 100 for providing content to a user. The example environment 100 includes a network 102, such as a local area network (LAN), a wide area network (WAN), the Internet, or a combination thereof. The network 102 connects user devices 106 (e.g., user devices 106a, 106b), content providers 108, a content management system 110, and a search system 112. The example environment 100 may include many thousands of user devices 106 and content providers 108. The content providers 108 can be, for example, advertisers. Other types of content providers are possible.

A user device 106 is an electronic device that is under control of a user and is capable of requesting and receiving resources over the network 102. Example user devices 106 include personal computers (e.g., the user device 106b), tablet computers, mobile communication devices (e.g., the user device 106a), televisions, set top boxes, personal digital assistants, digital cameras, such as a digital camera 106c, and other devices that can send and receive data over the network 102. A user device 106 typically includes one or more user applications, such as a web browser, to facilitate the sending and receiving of data over the network 102. Some or all user devices 106 can interface with a scanner 114 or with the digital camera 106c.

A user 116 can use the mobile device 106a, the digital camera 106c, or the scanner 114 to capture an image. For example, a camera on the mobile device 106a or the digital camera can capture an image of a scene or an image of a document. The scanner 114, for example, can be used to capture an image of a document. Other devices can be used to capture an image. As described in more detail below, other information can be captured in association with the image, such as location information, other images, audio signals (e.g., audio commands), and other context information.

A captured image 118 can be provided to the content management system 110. The captured image 118 can be provided as a download/upload or in association with an application that is executing on a device that captured the image. In some implementations, the user 116 can use an application that is associated with (e.g., provided by or linked to) the content management system 110 to capture the image 118 and the application can be configured to automatically send captured images 118 to the content management system 110. In some implementations, images are captured over time and provided in a batch to the content management system 110. In some implementations, captured images 118 are uploaded in near real time. In some implementations, the user provides a manual input to the application to request that the image 118 be sent to the content management system 110. In some implementations captured images are provided during predetermined periods, such as non-peak, low usage or high bandwidth periods, and held during other periods.

The content management system 110 can evaluate the received image 118 to identify content within the image 118 or suggested by the image 118. For example, a text recognizer 120 can use optical character recognition (OCR) to identify text included in the image 118. As another example, an object recognizer 122 can use object recognition techniques to identify objects included in the image 118. Other tools can be used to identify content included in or suggested by a received image 118.

Other information can be received along with an image. For example, metadata related to the image can be provided, wherein the metadata can include information about the image capture/generation device (e.g., the camera used to acquire the image), time of image capture, location of image capture or other related information.

An offer identifier 124 can identify a set of offers from an offers data store 126 based on the content identified from the image 118 and the other information received. For example, an offer can be identified if a keyword associated with the offer relates to content identified from the image 118. As described in more detail below, other information, such as location information and other contextual information can be used to identify the offers. In some implementations, offers can be identified based on the content identified from the image 118 and from information associated with the user that is identified from a user profiles data store 128. The user profile information can be based, for example, on user activities related to the content management system 110, the search system 112, and/or one or more other systems.

Offers can be of the form of advertisements, promotions, coupons, testimonials, discounts, incentives, suggestions, sample content, trials, or other forms of sponsored content. Offers can be associated with a content sponsor and can include selection criteria that are used to determine when and how a given offer is presented to a user. Selection of offers is discussed in greater detail below.

An offer sheet generator 130 can generate an offer sheet that includes the identified offers. The offer sheet can be provided to the user device 106a. The user 116 can view the offer sheet and previously generated offer sheets using, for example, an offer sheet browser 131. For example, previously generated offer sheets can be stored in an offer sheet data store 132 and can be retrieved in response to a request to view a particular offer sheet. An offer sheet can be named/or otherwise labeled for ease of indexing and retrieval. For example, a name or label associated with the image 118 can be used as (or to generate) a label for a given offer sheet. Other data can be associated with the offer sheet such as date, time, location, user or other data related to the generation of the offer sheet or the image from which it was derived.

A previously generated offer sheet can be shared. For example, the user 116 can share an offer sheet with a user 134. In some implementations, the shared offer sheet can be customized for the user 134, such as based on information associated with the user 134 that is identified in the user profiles data store 128. Such information can/will be different than the information associated with the user 116. When the offer sheet is shared, customized information can be provided to the user 134 while still maintaining a general theme associated with the offer sheet. The shared offer sheet can be provided to the user device 106b. For example, an offer sheet that relates to automobiles may include one or more offers that are the same for both users 116 and 134 (e.g., a general offer for auto financing) and others that are different (e.g., different offers from specific dealerships that are in proximity to a location associated with each of the respective users). A shared offer sheet can be customized for a particular user based on other factors, such as user activity (e.g., recent search requests sent to the search system 112).

A content provider 108 or content sponsor can create a content campaign associated with one or more content items (e.g., offers) using tools provided by the content management system 110. A content campaign can specify that a content item associated with a given campaign is eligible to be included in generated offer sheets. The content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 136 which define a content campaign. The content campaign can be created and activated for the content provider 108 according to the parameters 136 specified by the content provider 108. The campaign parameters 136 can be stored in a parameters data store 138. Campaign parameters 136 can include, for example, a campaign name, a preferred content network for placing content, a budget for the campaign, start and end dates for the campaign, a schedule for content placements, content (e.g., offers or other forms of creatives), bids, and selection criteria. Selection criteria can include, for example, a language, one or more geographical locations or websites, and/or one or more selection terms. As another example, a content provider 108 can designate as part of the selection criteria that one or more content items are eligible for presentation on a generated offer sheet.

Although illustrated as a client-server implementation, in some implementations, a service located on and installed on a user device 106 can evaluate a captured image, identify eligible offers from a database of offers stored on the user device 106, and generate an offer sheet to be presented on the user device 106 without any or limited interaction with a central service. Other system configurations are possible.

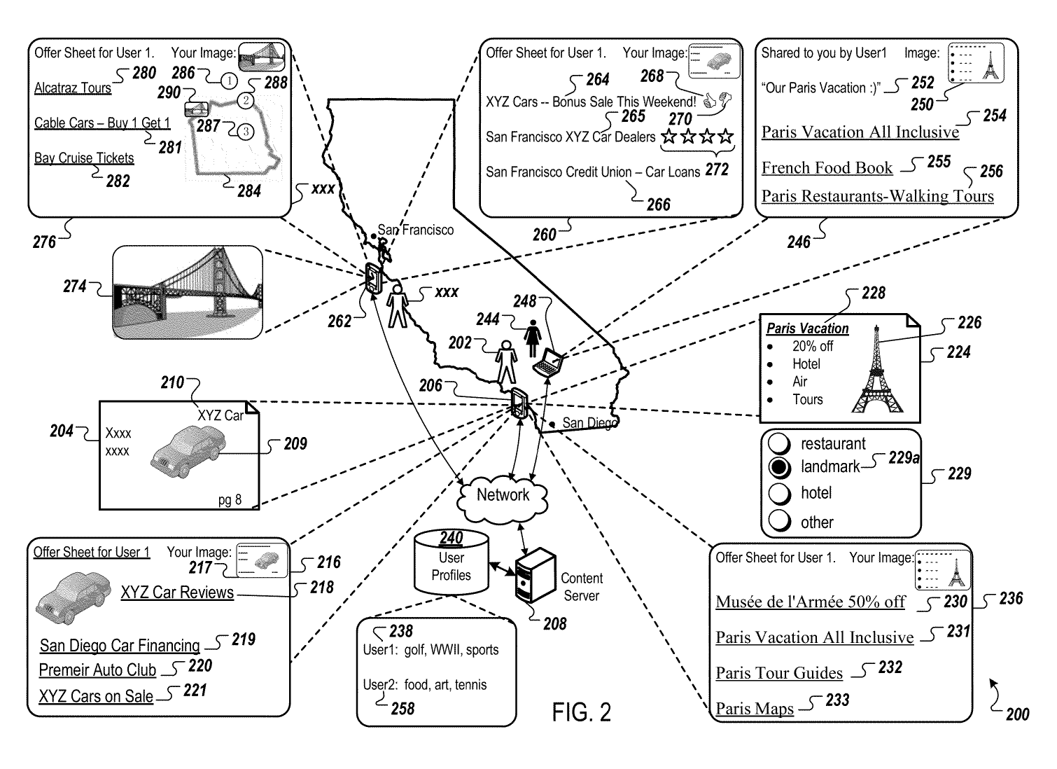

FIG. 2 is a block diagram of an example system 200 for providing an offer sheet to a user. A user 202 (e.g., “user one”) located in or near San Diego captures an image 204 using a mobile device 206. The image 204 can be sent to a content server 208. In some implementations, location information indicating a location where the image 204 was captured can be sent along with or in association with the image 204. In some implementations, a user identifier (e.g., that is included with or as part of a cookie) can be received along with or in association with the image 204.

The content server 208 can evaluate the image 204 to identify content included in the image. For example, the content server 208 can use object recognition techniques to identify objects included in the image, such as an image 209 of a car. As another example, the content server 208 can use OCR to identify text included in the image, such as the name 210 of a car model.

The content server 208 can identify a set of offers for the user 202 based, for example, on identified text (e.g., the car name 210), on identified objects (e.g., the car image 209), and/or on location information indicating where the image 204 was captured. The content server 208 can generate an offer sheet 216 that includes the set of identified offers. In some implementations, the offer sheet 216 includes a thumbnail 217 of the received image and includes offers 218, 219, 220, and 221. As illustrated by the offer 218, an identified offer can include an image. The offer 218, which is an offer for “XYZ Car Reviews”, can be identified, for example, based on the identified car name 210 and/or the identified car image 209. Similarly, the offer 221, which is an offer for XYZ cars for sale, can be identified based on the identified car name 210 and/or the identified car image 209. The offer 219, which is an offer for San Diego car financing, can be identified, for example, based on the identified car name 210, the identified car image 209, and on location information received with the image 204. The offer 220, which is for an elite auto club catering to wealthy car owners, can be identified, for example, based on the identified car name 210 and the identified car image 209.

As an example, the user 202 can take a picture of a vacation destination, for example, using the mobile device 202. An image 224 of the vacation destination can be provided to the content server 208. In some implementations, the user 202 can provide context information along with the image 224. For example, the user can, for example, speak an audible command that provides context for what the user is interested in related to the image. For example, the user can say “vacation”. The audible command can be recorded and can be sent to the content server 208 in association with the sending of the image 224.

As another example, in some implementations, the user 202 is presented a user interface such as a user interface 229, which includes a set of labels from which the user 202 can select a label designation which provides context for a supplied image. For example, the user 202 can select a landmark label 229a. In some implementations, the user 202 can enter a custom label using the user interface 229. In some implementations, the set of labels are determined by the content server 208 based on content identified in the image 224.

For example, the content server 208 can evaluate image data of the image 224 and can identify an object 226 as an Eiffel Tower object and can identify text 228 (e.g., including “Paris” and “vacation”). The content server 208 can identify a set of offers based on one or more of the identified Eiffel Tower object 226, the identified text 228, a received audio input (e.g., an audible command), a received label designation, and/or a user profile associated with the user 202. The content server 208 can generate an offer sheet 236 that includes the identified set of offers, including offers 230, 231, 232, and 233.

The offers 231, 232, and 233 are offers for a Paris vacation, a Paris tour guide, and Paris maps, respectively, and may have been identified, for example, based on one or more of the identified Eiffel Tower object 226, the identified text 228, a received audio input, or a received label designation. The offer 230, which is for an army museum, may have been identified, at least in part, based on a user profile associated with the user 202. For example, the content server 208 may have identified a user profile 238 for the user 202 in a user profile data store 240 and may have identified a “World War II” interest for the user 202 in the user profile 238. The content server 208 may have identified the offer 230 as being associated with the World War II interest of the user 202 and as being associated with, for example, the identified text 228.

In some implementations, the user 202 can share the offer sheet 236 with another user, such as a user 244. Upon sharing the offer sheet 236, a shared offer sheet 246 can be provided to a user device 248 of the user 244. In some implementations, the shared offer sheet 246 can include a representation (e.g., a thumbnail 250) of the image 224, and can include an annotation 252 added by the user 202. The user 202 can annotate, or provide metadata, for the shared offer sheet 246 and/or for the personal offer sheet 236.

The shared offer sheet 246 includes offers 254, 255, and 256. The offers included in the shared offer sheet 246 can be the same set of offers as included in the offer sheet 236. As another example, some or all of the offers included in the shared offer sheet 246 can be different from offers included in the offer sheet 236. For example, some or all of the offers included in the shared offer sheet 236 can be customized for the receiving user 244, such as based on a user profile 258 associated with the user 244. For example, the offers 255 and 256, which are for a French food book and for Paris restaurants walking tours, respectively, can be identified based on an interest of “food” of the user 244 as determined from the user profile 258 and based on content identified from the image 224, such as the identified text 228. In some implementations, a section of the shared offer sheet 246 is customized for the user 244 (e.g., the section can be an “offers for you” section). Other sections of the shared offer sheet 246 can include offers that are also included on the offer sheet 236. For example, the offer 254 corresponds to the offer 231.

A shared offer sheet (e.g., the offer sheet 246), as well as an original offer sheet (e.g., the offer sheet 236, the offer sheet 216), can be dynamic, where the content of the shared or original offer sheet change over time in subsequent viewings of the shared or original offer sheet. For example, an offer sheet can be maintained as a business page that is accessible to one or more users. A user can, for example, use an offer sheet browser and select a previously generated offer sheet for viewing.

For example, the user 202 may open the previously generated offer sheet 216 while vacationing in or near San Francisco, as illustrated by an offer sheet 260 displayed on a user device 262. The offer sheet 260 can be updated, as compared to the offer sheet 216, based, for example, on one or more of a time of day, time of year, updated profile or interests or location of the user device 262. Updated offers can include offers that may not have been relevant when the user 202 previously viewed the offer sheet 216. For example, the offer sheet 260 includes offers 264, 265, and 266. The offer 264 may be identified, for example, based on the offer 264 corresponding to a sale occurring on the current day and on the offer 264 being related to content identified from the image 204 which is associated with the offer sheet 260. The offers 265 and 266 may be identified, for example, based on the location of the user device 262 and on the respective offers 265 and 266 each being related to content identified from the image 204.

In some implementations, the user 202 can rate and/or review an offer. For example, a user can review the offer 264, 265, or 266 and provide feedback by selecting a review link (not shown). As another example, the user can provide a rating for one or more of the offers 264, 265, or 266. For example, the user can select a thumbs-up image 268 or a thumbs-down image 270 to rate the offer 264 or can select one or more stars 272 to rate the offer 265. Rating and review information can be provided to the content server 208. The content server 208 can evaluate previously-received rating and review information when selecting future offers for the user 202 and for users in general. For example, the content server 208 can update the user profile 238 with rating and review information and can use the updated user profile information when identifying future offers for the user 202. For example, a new interest can be added to the user profile 238 based on positive reviews received from the user 202. As another example, the user profile 238 can be updated to indicate the user 202 does not like certain things based on the receipt of negative ratings or reviews from the user 202.

The identification of content associated with a captured image can be based on the location of the user when the image is captured. For example, the user 202 can use the user device 262 to capture an image 274 of the Golden Gate bridge. The image 274 can be sent to the content server 208. The content server 208 can identify the image 274 as an image of the Golden Gate bridge, based, at least in part, on the San Francisco location of the user device 262. The content server 208 can identify offers based on the identified Golden Gate bridge object and the San Francisco location. An offer sheet 276 including offers 280, 281, and 282 can be generated and provided to the user device 262. The offer sheet 276 includes a map 284 of the San Francisco area. The map 284 includes indicators (e.g., pushpins) 286, 287, and 288 which correspond, respectively, to locations associated with the offers 280, 281, and 282. In some implementations, the map 284 includes a representation (e.g., thumbnail) 290 of the image 274 placed on the map 284 corresponding to the location at which the image 274 was captured.

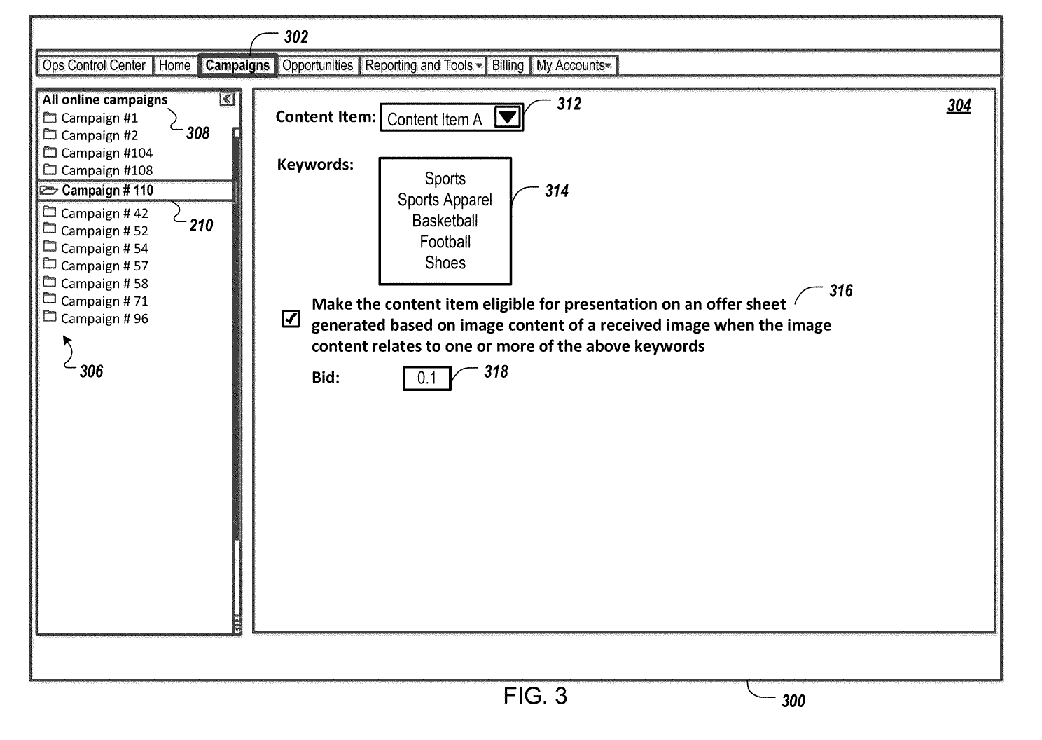

FIG. 3 illustrates an example campaign management user interface 300. The user interface 300 can be included, for example, in one or more user interfaces that a user, such as a content item provider or content sponsor, can use to configure a campaign. The content item provider can select a tab 302 to display a campaign configuration area 304. The content item provider can view a list 306 of campaigns by selecting a control 308. The content item provider can edit an existing campaign in the campaign configuration area 304 by selecting the name of an existing campaign (e.g., a name 310) in the campaign list 306. The content item provider can select a content item (e.g., an offer) associated with the campaign using a control 312.

A control 314 lists keywords that are associated with the selected content item and/or with the content item provider. The content item provider can provide (e.g., enter) some or all of the keywords using the control 314. As another example, some or all of the keywords in the control 314 can be automatically determined and suggested to the content item provider. For example, some or all of the keywords in the control 314 can be automatically determined from one or more web pages that are associated with a web site of the content item provider or from other information provided by or otherwise associated with the content item provider. Some or all of the keywords in the control 314 can be determined based on the content of the selected content item.

The content item provider can select a control 316 to configure selection criteria that indicates that the selected content item is eligible for presentation on an offer sheet generated based on image content of a received image when the image content relates to one or more of the keywords included in the control 314. A bid associated with the selection criteria associated with the control 316 can be configured using a control 318.

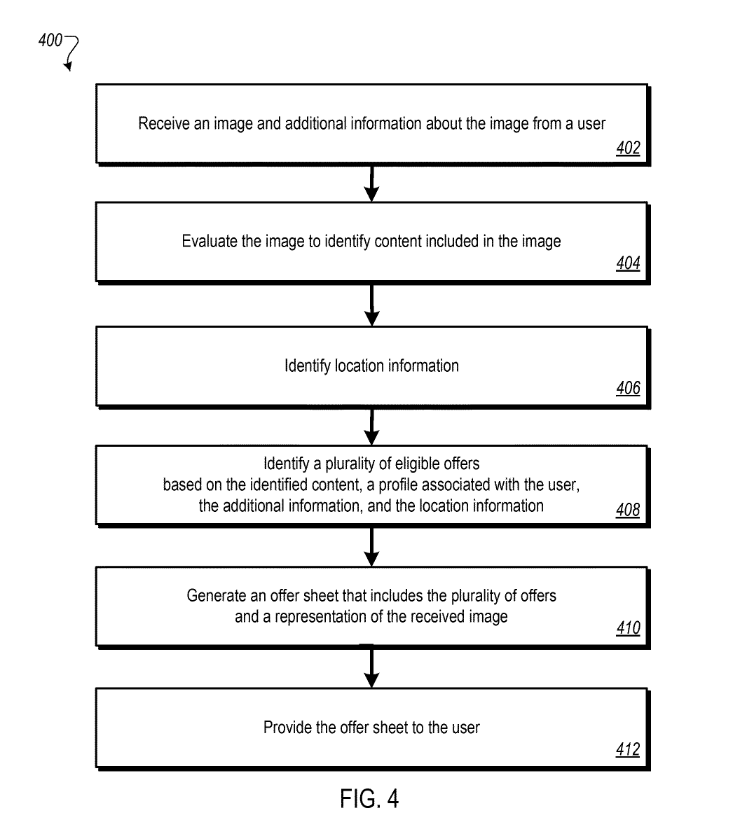

FIG. 4 is a flowchart of an example process 400 for providing content to a user. The process 400 can be performed, for example, by the content management system 110 described above with respect to FIG. 1 or the content server 208 described above with respect to FIG. 2.

An image and, in some implementations, additional information about the image is received from a user device (402). The image can be, for example, a digital image provided by an image capture device, such as a digital camera or a scanner. The image can be, for example, part of a scene. For example, video content that includes audio and a plurality of images can be received. In some implementations, a plurality of still images can be received. In some implementations, the image can be an image of a document.

In some implementations, the additional information can include context information, such as one or more audio (e.g., command) signals that provide context for what the user is interested in related to the image. As another example, context information providing context for what the user is interested in related to the image can be provided by one or more user inputs provided by the user on a user interface. Other examples of additional information include the user designating the image (e.g. “liking” the image), or providing comments about the image (e.g., “this picture relates to my upcoming trip to Paris”).

The image is evaluated to identify content included in the image (40). For example, optical character recognition can be used to identify text included in the image. As another example, object recognition techniques can be used to identify objects included in the image. Information from the evaluating can be stored in a profile associated with the user for use in identifying other content to serve to the user at another time. For example, one or more interests can be added to the profile based on the identified content.

When the image is an image of a document, the source of the document can be identified. Textual content and/or image content can otherwise be used to identify the source of the image. When a plurality of images are received, the plurality of images can be evaluated, including the identifying of text and/or objects in some or all of the plurality of images. When the image is part of a scene, the scene can be evaluated, including the evaluation of images and audio associated with the scene.

Location information is identified (406). For example, the location information can include one or more of location information indicating where the image was captured, location information indicating the current location of the user, or location information determined from the image. For example, the image may have been captured at or near a user's home in San Jose, Calif., the image may include a sign relating to New York style pizza resulting in location information of New York being identified, and the user's current location may be San Francisco, Calif. In some implementations, the location information can be used to assist in identifying content included in the image. For example, an object may be identified in the image and can be identified as a particular building or other landmark based on the location information.

A plurality of eligible offers are identified based on the identified content, the profile associated with the user, the additional information, and the location information (408). For example, the plurality of offers can include offers that are each associated with one or more keywords that are related to the identified content. As another example, one or more of the offers can be identified based on information in the profile being related to the identified image content and matching one or more keywords associated with one or more offers. As yet another example, when context information is received with the image, the context information can be used to assist in identifying the eligible offers. One or more offers can be identified based on the location information. For example, one or more offers may have an associated location that is within a threshold distance of the location represented by the received location information. When a plurality of images or a scene is received, at least one offer can be identified based on the evaluating of the plurality of images or the scene, respectively.

Continuing the example from above where the location information indicates that the image was captured at or near a user's home in San Jose, Calif., the image relates to New York style pizza, and the user's current location is San Francisco, Calif., one or more offers relating to New York style pizza restaurants at or near San Francisco or San Jose, Calif. can be identified.

An offer sheet is generated that includes the plurality of offers and, in some implementations, a representation of the received image (410). The representation of the received image can be, for example, a thumbnail image. In some implementations, offer sheets can include representations of multiple received images. For example, when a plurality of images are received, the offer sheet can include representations (e.g., thumbnails) of some or all of the plurality of images.

The offer sheet can be, for example, a web page. In some implementations and for some images, the offer sheet can include a map portion that includes a map of an area related to a location associated with the image. The map can, for example, include an indicator, pushpin or other marker related to one, some or all of the plurality of offers.

In some implementations, the offer sheet enables the user to provide feedback on each offer (e.g., a thumbs-up/thumbs-down indication, a rating from one to four stars). The feedback can be used in future identification of offers or other purposes. For example, offers for particular entities (e.g., particular restaurants), particular types of entities, or particular types of services might get a higher weighting or a lower weighting in an identification process based on previously received feedback.

The offer sheet is provided to the user (412). For example, the offer sheet can be provided to a user device of the user, for presentation on the user device. The user can, for example, name the offer sheet and/or provide other metadata to augment the offer sheet.

The offer sheet can be provided to the user, for example, in direct response to the receiving of the image. As another example, offer sheets can be maintained as business pages that are accessible by the user and that are configured to be updated at each viewing by the user. For example, the identification of offers can be re-performed at each viewing and offers can be identified, for example, based on the current day, current time of day, current location of the user, current information in the user profile of the user, feedback received from the user since the previous viewing of the offer sheet by the user, as well as on the identified image content and on other context information.

In some implementations, offer sheets can be shared with other users. The shared offer sheet can be customized for the other user. For example, the shared offer sheet can be based, at least in part, on information in a user profile associated with the user to which the offer sheet is shared.

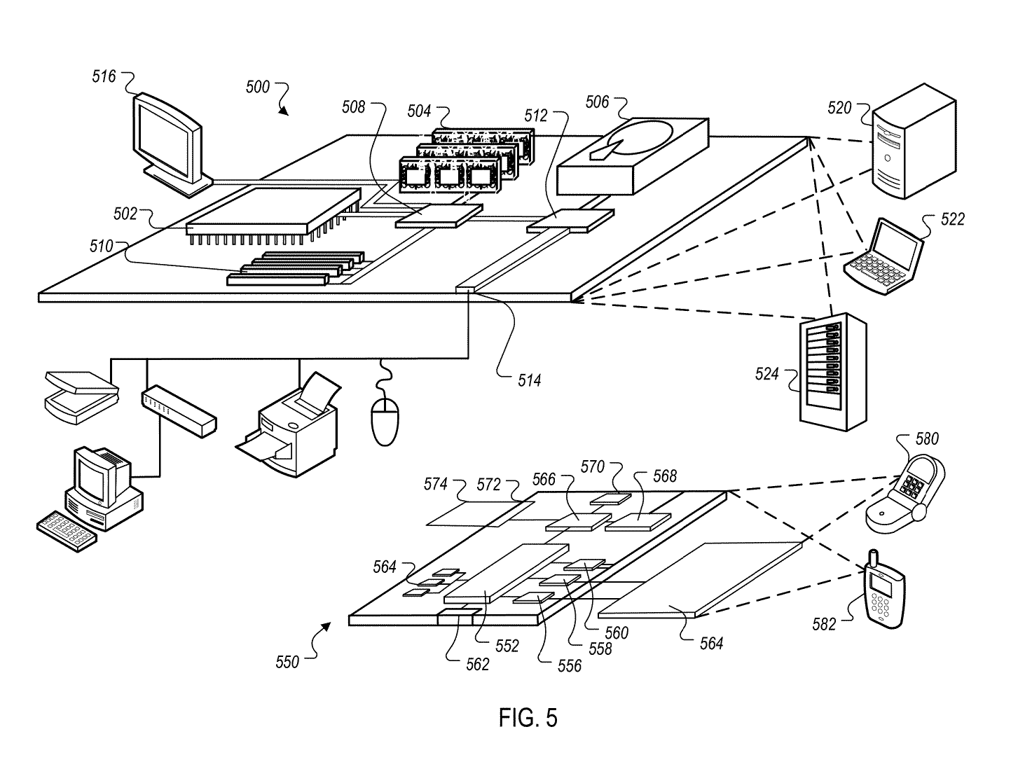

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. The computer-readable medium is not a propagating signal. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of duties is illustrative only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communication audibly using audio codec 560, which may receive spoken information from a user and convert it to usable digital information. Audio codex 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
receiving an image from a user and additional information about the image; evaluating the image to identify content included in the image including using optical character recognition to identify text included in the image and object recognition techniques to identify objects included in the image;
identifying location information including one or more of location of where the image was captured, location associated with the content included in the image, or a current location of the user;
identifying a plurality of eligible offers based on the identified content, the location information, the additional information, and a profile associated with the user;
generating an offer sheet that includes the plurality of offers and a representation of the received image; and
providing the offer sheet to the user.

2. The method of claim 1 wherein the location information is used to assist in identifying content included in the image.

3. The method of claim 1 further comprising receiving a plurality of images and evaluating the plurality of images, wherein identifying the plurality of offers is based on the evaluating.

4. The method of claim 1 wherein the image is part of a scene, wherein the method includes receiving the scene, evaluating the scene including evaluating images and audio associated with the scene, and wherein identifying is based on the evaluating.

5. The method of claim 1 wherein receiving the additional information includes receiving context information from the user along with the image and wherein the context information is used to identify the eligible offers.

6. The method of claim 6 wherein the context information is of the form of an audible command signal that provides context for what the user is interested in related to the image.

7. The method of claim 1 further comprising enabling the user to share the offer sheet with other users.

8. The method of claim 8 wherein enabling includes providing a control to enable the user to name the offer sheet, store the offer sheet, augment the offer sheet with other metadata, or share the offer sheet with the other users.

9. The method of claim 1 wherein generating the offer sheet includes generating a map portion for inclusion in the offer sheet including a map of an area related to a location associated with the image.

10. The method of claim 10 wherein generating the map portion includes generating a map including one or more indicators, wherein each indicator is associated with a location on the map that is relevant to an offer of the plurality of offers.

11. The method of claim 1 wherein the offer sheet is maintained as a business page accessible by the user that is configured to be updated at each viewing by the user.

12. The method of claim 1 further comprising storing information from the evaluating in the profile for use in identifying other content to serve to the user at another time.

13. A system comprising:
a text recognizer configured to identify text included in an image received from a user;
an object recognizer configured to identify objects included in the image;
an offer identifier configured to:
identify location information including one or more of location of where the image was captured, location associated with the content included in the image or a current location of the user;
identify a plurality of eligible offers based on the identified content, the location information, additional information received with the image, and a profile associated with the user; and
an offer sheet generator configured to:
generate an offer sheet that includes the plurality of offers and a representation of the received image; and
provide the offer sheet to the user.

14. The system of claim 13 wherein the location information is used to assist in identifying content included in the image.

15. The system of claim 13 wherein the offer sheet generator is further configured to generate a map portion for inclusion in the offer sheet including a map of an area related to a location associated with the image.

16. The system of claim 13 wherein the offer sheet is maintained as a business page accessible by the user that is configured to be updated at each viewing by the user.

17. A computer program product tangibly embodied in a computer-readable storage device and comprising instructions that, when executed by a processor, cause the processor to:
receive an image from a user and additional information about the image;
evaluate the image to identify content included in the image including using optical character recognition to identify text included in the image and object recognition techniques to identify objects included in the image;
identify location information including one or more of location of where the image was captured, location associated with the content included in the image, or a current location of the user;
identify a plurality of eligible offers based on the identified content, the location information, the additional information, and a profile associated with the user;
generate an offer sheet that includes the plurality of offers and a representation of the received image; and
provide the offer sheet to the user.

18. The product of claim 17 wherein the location information is used to assist in identifying content included in the image.

19. The product of claim 17 wherein the offer sheet generator is further configured to generate a map portion for inclusion in the offer sheet including a map of an area related to a location associated with the image.

20. The product of claim 17 wherein the offer sheet is maintained as a business page accessible by the user that is configured to be updated at each viewing by the user.
